(19) United States
(12) Patent Application Publication
(10) Pub. No.: US 2022/0252211 A1
(43) Pub. Date: Aug. 11, 2022

(54) RIVET RIVETING FOLDING FRAME

(71) Applicant: DONGGUAN YIJUN INDUSTRIAL CO., LTD., DONGGUAN (CN)

(72) Inventor: ZHIQIANG DU, HUANGSHI (CN)

(21) Appl. No.: 17/169,562

(22) Filed: Feb. 8, 2021

(51) Int. Cl. F16M 11/20; F16B 5/04; F16M 11/28; F16M 11/10; F21V 21/28

(52) U.S. Cl. CPC F16M 11/2064; F16B 5/04; F16M 11/28; F16M 11/10; F21V 21/28; F21S 6/003; F16M 2200/022; F16M 2200/063; F16M 2200/068; F16M 2200/08; F16M 2200/044

(57) ABSTRACT

The present invention relates to the field of folding frames, and in particular, to a rivet riveting folding frame. While the rivet riveting folding frame realizes the bending for adjustment of angle, the movable connections are all realized by riveting of rivets, and all the riveting positions of rivets have arc transitions, so that the phenomenon that scratching by screws and nuts is prone to occur in the prior art is avoided, and young users can use them at ease. In addition, the rivet riveting adopted in the present invention can greatly reduce the processing difficulty and improve the assembly efficiency.

### TECHNICAL FIELD

The present invention relates to the field of folding frames, and in particular, to a rivet riveting folding frame.

### BACKGROUND

Traditional folding frame brackets are generally assembled by screws and nuts. However, as the traditional assembly by screws and nuts requires corresponding screwing devices and nut fitting devices, the overall assembly requires more stations, and the assembly is difficult, so the overall assembly efficiency is not high. Meanwhile, in the prior art, the edges of screws and nuts are relatively sharp, so hand scraping is prone to occur, and there are potential safety hazards. Therefore, it is urgent to provide a rivet riveting folding frame which can reduce the assembly difficulty, improve the assembly efficiency, and avoid hand scraping.

### SUMMARY

In order to solve the above problems, the present invention provides a rivet riveting folding frame, in which rivet riveting are adopted, and all the rivet riveting have arc transitions, so that the phenomenon that scratching by screws and nuts is prone to occur in the prior art is avoided, and young users can use them at ease. In addition, the rivet riveting adopted can greatly reduce the processing difficulty and improve the assembly efficiency.

In order to realize the above purpose, the present invention adopts the following technical scheme: a rivet riveting folding frame, including a folding rod assembly, wherein the folding rod assembly includes an upper connecting rod group and a lower connecting rod group; the lower connecting rod group includes a first lower connecting pipe, a second lower connecting pipe, and a gun-shaped bracket; lower ends of the first lower connecting pipe and the second lower connecting pipe are movably riveted on two inner sides of the gun-shaped bracket by a rivet, respectively; the upper connecting rod group includes a first upper connecting pipe, a second upper connecting pipe, a first connecting bracket, and a second connecting bracket; upper ends of the first lower connecting pipe and the second lower connecting pipe are movably riveted on an inner side surface of the first connecting bracket by rivets; a lower end of the first upper connecting pipe is movably connected with the first connecting bracket; a lower end of the second upper connecting pipe is movably riveted on the first connecting bracket by a rivet; and upper ends of the first upper connecting pipe and the second upper connecting pipe are movably riveted on the second connecting bracket by rivets.

Further, the rivet riveting folding frame further includes a telescopic assembly and a base; the telescopic assembly includes a mounting sleeve and an elastic bolt; the mounting sleeve is fixedly arranged on the base and extends along a vertical direction, and one side of the mounting sleeve is provided with an assembling hole corresponding to the elastic bolt; an assembling pipe is integrally formed at a bottom of the gun-shaped bracket, the assembling pipe is movably arranged in the mounting sleeve and moves along an axial direction of the mounting sleeve, and the elastic bolt is assembled in the assembling hole and abuts against an outer wall of the assembling pipe, so that the assembling pipe is fixed at a specified position.

Further, the lower connecting rod group further includes a pair of first tension springs; both sides of a middle portion of the first lower connecting pipe are assembled with first spring buckles; one end of each of the two first tension springs is buckled to the first spring buckles, and the other ends of the two first tension springs are buckled to both sides of an upper end of the gun-shaped bracket.

Further, the upper connecting rod group further includes a first round head bolt and a first knob having a self-provided nut; the lower end of the first upper connecting pipe passes through the first connecting bracket and the first upper connecting pipe, and is connected with the first knob having the self-provided nut by the first round head bolt, thus realizing movable connection with the first connecting bracket.

Further, the upper connecting rod group further includes a pair of second tension springs; both sides of a middle portion of the first upper connecting pipe are assembled with second spring buckles, and both sides of the first connecting bracket are assembled with third spring buckles; one end of each of the two second tension springs is buckled to the second spring buckle, and the other ends of the two second tension springs are buckled to the third spring buckle.

Further, the clamping assembly further includes a second round head bolt, a conjoined clamp, lamp body, and a second knob having a self-provided nut; the second round head bolt passes through the second connecting bracket and the conjoined clamp, and is connected with the second knob having the self-provided nut; the conjoined clamp deforms and clamps the rotatable bracket.

Further, the rotatable bracket is connected with the lamp body or a mobile phone clip.

Further, the upper and lower ends of the second upper connecting pipe and the second lower connecting pipe are provided with assembling grooves, and a wiring protection sleeve is mounted in each of the assembling grooves; a wiring channel is provided in each of the wiring protection sleeves, and a wiring hole communicated with the wiring channel is provided in the surface of the wiring protection sleeve; and rivet holes for rivets to pass through are provided on both sides of the wiring protection sleeve.

Further, a layer of non-slip non-woven fabric is attached to a bottom surface of the base.

The present invention has the following beneficial effects:

1. In the present application, the upper ends of the first lower connecting pipe and the second lower connecting pipe are movably riveted on the inner side surface of the first connecting bracket by rivets; the lower end of the first upper connecting pipe is movably connected with the first connecting bracket; the lower end of the second upper connecting pipe is movably riveted on the first connecting bracket by rivets; the upper ends of the first upper connecting pipe and the second upper connecting pipe are movably riveted on the second connecting bracket by rivets, and the lamp body is connected with the second connecting bracket. While the desk lamp is bent to adjust an angle, the movable connections are all realized by riveting of rivets, and all the riveting positions of rivets have arc transitions, so that the phenomenon that scratching by screws and nuts is prone to occur in the prior art is avoided, and young users can use them at ease.

2. As the traditional assembly by screws and nuts requires corresponding screwing devices and nut fitting devices, the overall assembly requires more stations, and the assembly is difficult. In comparison, the rivet riveting adopted in the present application can greatly reduce the processing difficulty and improve the assembly efficiency.

### BRIEF DESCRIPTION OF THE DRAWINGS

FIG. 1 is a side view of a desk lamp constructed according to the present invention.

FIG. 2 is a schematic perspective view of the desk lamp constructed according to the present invention.

FIG. 3 is a side view of a mobile phone bracket constructed according to the present invention.

FIG. 4 is a schematic structural view of a floor lamp constructed according to the present invention.

FIG. 5 is a schematic structural view of an extended mobile phone bracket constructed according to the present invention.

FIG. 6 is a working principle diagram of a clamping assembly according to the present invention.

FIG. 7 is a working principle diagram of a telescopic assembly according to the present invention.

### LIST OF REFERENCE NUMERALS

1: Lamp body; 11: Rotatable bracket; 12: Conjoined clamp; 2: Folding rod assembly; 21: Upper connecting rod group; 211: First upper connecting pipe; 2111: Second tension spring; 2112: Second spring buckle; 2113: Third spring buckle; 212: Second upper connecting pipe; 22: Lower connecting rod group; 221: First lower connecting pipe; 2211: First spring buckle; 222: Second lower connecting pipe; 223: Gun-shaped bracket; 2231: Assembling pipe; 231: First connecting bracket; 232: Second connecting bracket; 241: First knob; 242: Second knob; 243: Second round head bolt; 224: First tension spring; 3: Base; 31: Mounting sleeve; 32: Elastic bolt; 4: Rivet; 5: Wiring protection sleeve; 6: Mobile phone clip; 7: Support rod.

### DETAILED DESCRIPTION

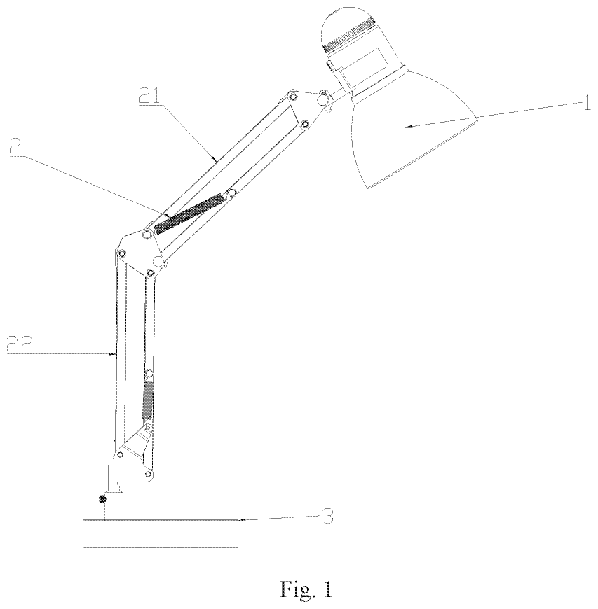

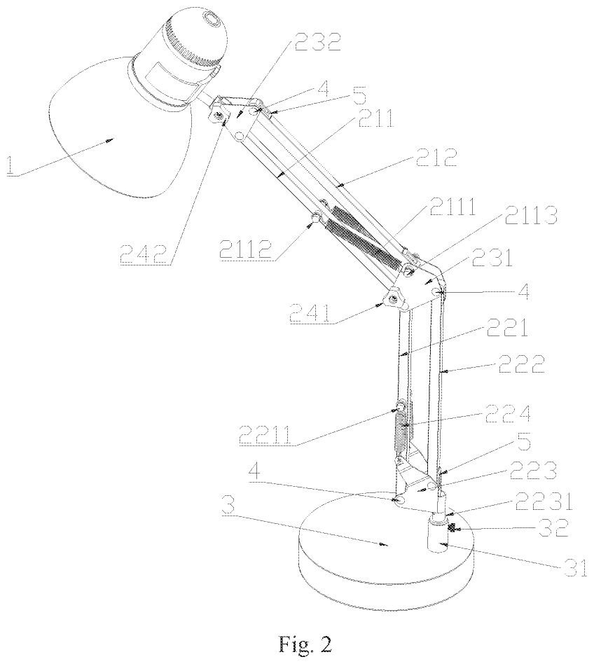

As shown in FIGS. 1 to 2, the present invention relates to a rivet riveting folding frame. The folding rod assembly 2 includes an upper connecting rod group 21 and a lower connecting rod group 22. The lower connecting rod group 22 includes a first lower connecting pipe 221, a second lower connecting pipe 222, and a gun-shaped bracket 223 connected to a base 3. Lower ends of the first lower connecting pipe 221 and the second lower connecting pipe 222 are movably riveted on two inner sides of the gun-shaped bracket 223 by a rivet 4, respectively. The upper connecting rod group 21 includes a first upper connecting pipe 211, a second upper connecting pipe 212, a first connecting bracket 231, and a second connecting bracket 232. Upper ends of the first lower connecting pipe 221 and the second lower connecting pipe 222 are movably riveted on an inner side surface of the first connecting bracket 231 by rivets 4. A lower end of the first upper connecting pipe 211 is movably connected with the first connecting bracket 231.A lower end of the second upper connecting pipe 212 is movably riveted on the first connecting bracket 231 by a rivet 4. Upper ends of the first upper connecting pipe 211 and the second upper connecting pipe 212 are movably riveted on the second connecting bracket 232 by rivets 4.

In the present application, the upper ends of the first lower connecting pipe 221 and the second lower connecting pipe 222 are movably riveted to the inner side surface of the first connecting bracket 231 by rivets 4. The lower end of the first upper connecting pipe 211 is movably connected with the first connecting bracket 231. The lower end of the second upper connecting pipe 212 is movably riveted on the first connecting bracket 231 by a rivet 4. The upper ends of the first upper connecting pipe 211 and the second upper connecting pipe 212 are movably riveted on the second connecting bracket 232 by rivets 4. A lamp body 1 is connected with the second connecting bracket 232. While the rivet riveting folding frame is bent for adjustment of angle, the movable connections are all realized by riveting of rivets 4, and all the riveting positions of rivets 4 have arc transitions, so that the phenomenon that scratching by screws and nuts is prone to occur in the prior art is avoided, and young users can use them at ease. As the traditional assembly by screws and nuts requires corresponding screwing devices and nut fitting devices, the overall assembly requires more stations, and the assembly is difficult. In comparison, the riveting of rivets 4 adopted in the present application can greatly reduce the processing difficulty and improve the assembly efficiency.

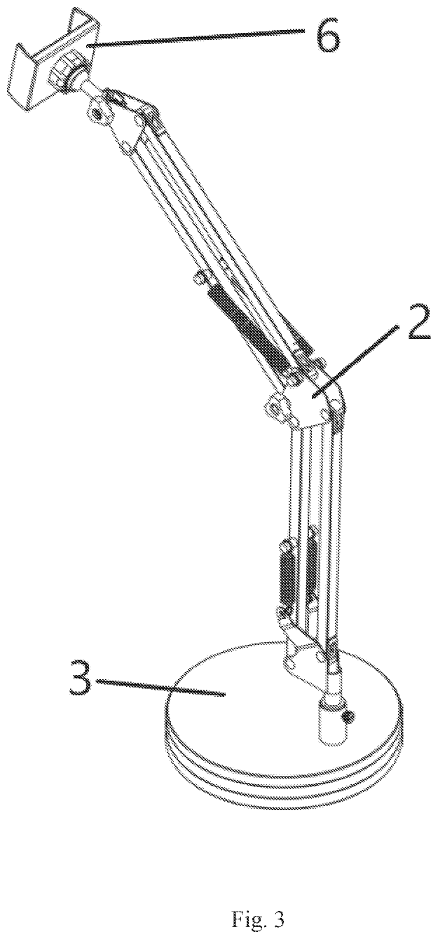

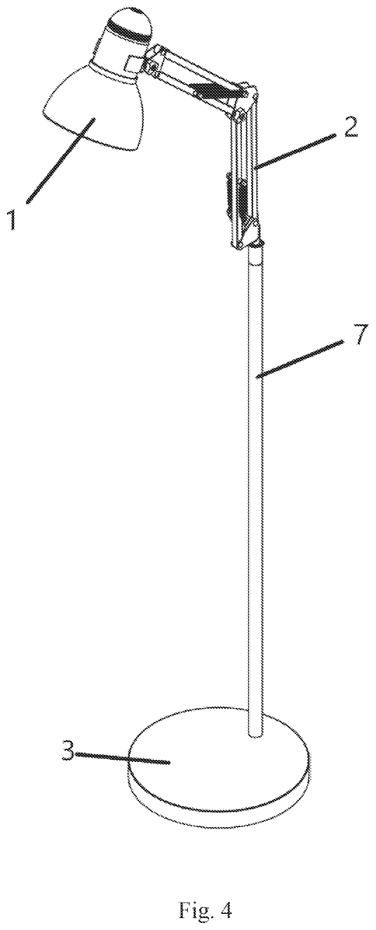

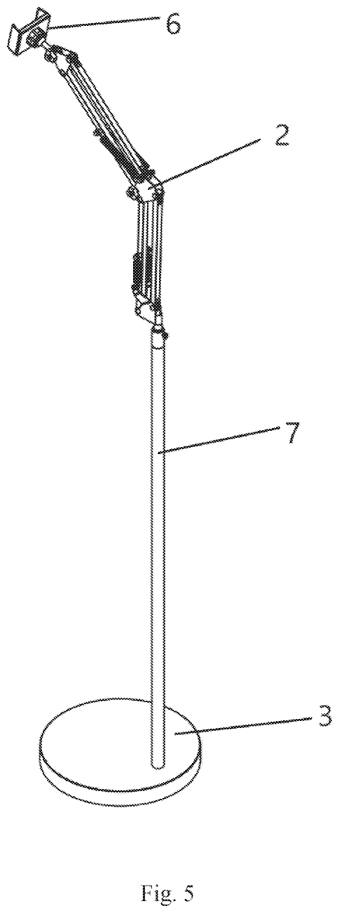

As shown in FIGS. 1 to 2, a folding desk lamp is constructed by assembling a rivet riveting folding frame of the present application with a lamp body 1 and a base 3. As shown in FIG. 3, a mobile phone bracket is constructed by assembling a rivet riveting folding frame with a mobile phone clip 6 and a base 3. As shown in FIG. 4, a support rod 7 is added to the folding desk lamp, one end of the support rod 7 is directly fixed on the base 3, and the other end of the support rod 7 is connected with the bottom of the mounting sleeve 31, thus constructing a floor lamp. As shown in FIG. 5, an extended mobile phone bracket is constructed by adding a support rod 7 to the mobile phone bracket.

Further, in order to improve the adjustability of the rivet riveting folding frame of the present application, a telescopic assembly is further included. The telescopic assembly includes a mounting sleeve 31 and an elastic bolt 32. The mounting sleeve 31 is fixedly arranged on the base 3, and one side of the mounting sleeve 31 is provided with an assembling hole corresponding to the elastic bolt 32. An assembling pipe 2231 is integrally formed at the bottom of the gun-shaped bracket 223, and the assembling pipe 2231 is movably arranged in the mounting sleeve 31 and moves along an axial direction of the mounting sleeve 31. The elastic bolt 32 is assembled in the assembling hole and abuts against an outer wall of the assembling pipe 2231, so that the assembling pipe 2231 is fixed at a specified position. After loosening the elastic bolt 32, the assembling pipe 2231 may be controlled to move along the axial direction of the mounting sleeve 31, and when the assembling pipe 2231 is adjusted to a proper position, the elastic bolt 32 may be tightened.

Further, in order to ensure that the angle of the rivet riveting folding frame can be adjusted normally, the lower connecting rod group 22 of the present application further includes a pair of first tension springs 224. Both sides of a middle portion of the first lower connecting pipe 221 are assembled with first spring buckles 2211. One end of each of the two first tension springs 224 is buckled to the first spring buckles 2211, and the other ends of the two first tension springs 224 are buckled to both sides of an upper end of the gun-shaped bracket 223. The first tension spring 224 can provide a pulling force to prevent the lamp body 1 or the mobile phone clip 6 and the lower connecting rod group 2.2 from falling due to their own weights, and at the same time, the first tension spring 224 can ensure the shape of the rivet riveting folding frame.

Further, the upper connecting rod group 21 further includes a first round head bolt and a first knob 241 having a self-provided nut. The lower end of the first upper connecting pipe 211 passes through the first connecting bracket 231 and the first upper connecting pipe 211, and is connected with the first knob 241 having the self-provided nut by the first, round head bolt, thus realizing movable connection with the first connecting bracket 231. In the present application, the angle adjustment of the upper connecting rod group 21 and the first connecting bracket 231 can be realized by the first round head bolt and the first knob 241 having the self-provided nut. And in order to further avoid hand scratching by bolts, round head bolts are adopted as the screws in the present application.

Further, in order to ensure that the angle of the rivet riveting folding frame can be adjusted normally, the upper connecting rod group 21 further includes a pair of second tension springs 2111. Both sides of a middle portion of the first upper connecting pipe 211 are assembled with second spring buckles 2112, and both sides of the first connecting bracket 231 are assembled with third spring buckles 2113. One end of each of the two second tension springs 2111 is buckled to the second spring buckle 2112, and the other ends of the two second tension springs 2111 are buckled to the third spring buckle 2113.

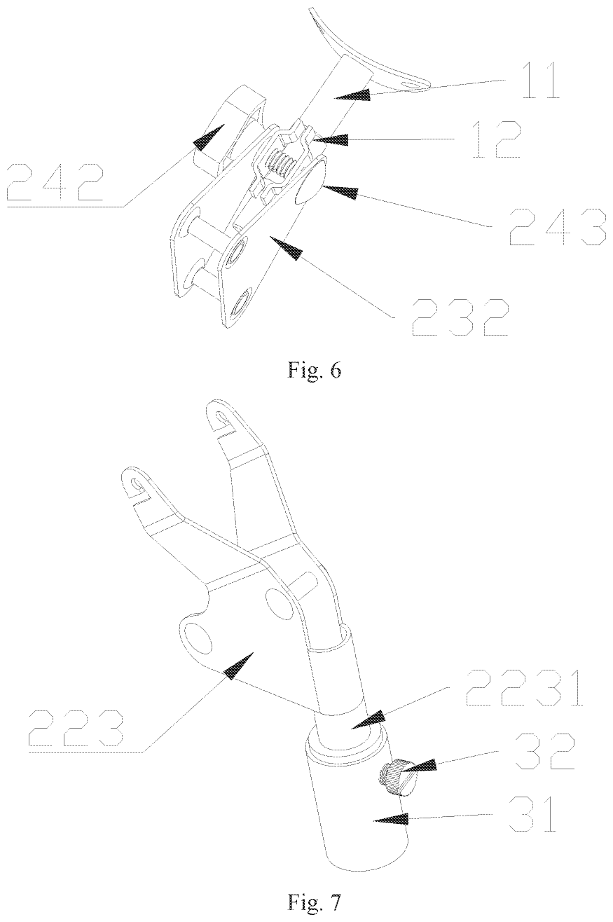

As shown in FIGS. 6 to 7, the rivet riveting folding frame further includes a clamping assembly. The clamping assembly includes a second round head bolt 243, a conjoined clamp 12, and a second knob 242 having a self-provided nut. The lamp body 1 is connected with a rotatable bracket 11. The second round head bolt 243 passes through the second connecting bracket 232 and the conjoined damp 12, and is connected with the second knob 242 having the self-provided nut. The rotatable bracket 11 is assembled with the lamp body 1 or the mobile phone clip 6, and at the same time, the conjoined clamp 12 deforms and clamps the rotatable bracket 11. A user may first loosen the second knob 242, then turn the lamp body 1 or the mobile phone clip 6 to an appropriate angle, and then tighten the second knob 242 to deform the conjoined clamp 12 and clamp the rotatable bracket 11.

Further, the upper and lower ends of the second upper connecting pipe 212 and the second lower connecting pipe 222 are provided with assembling grooves, and a wiring protection sleeve 5 is mounted in each assembling groove. A wiring channel is provided in the wiring protection sleeve 5, and a wiring hole communicated with the wiring channel is provided in the surface of the wiring protection sleeve 5, and rivet holes for rivets 4 to pass through are provided on both sides of the wiring protection sleeve 5. In order to facilitate routing, a wiring protection sleeve 5 with a built-in wiring channel is provided, and a wiring hole communicated with the wiring channel is provided in the surface of the wiring protection sleeve 5, so that a user only needs to penetrate wires through the wiring hole. At the same time, the edges of the second upper connecting pipe 212 or the second lower connecting pipe 222 can be prevented from scratching the wire harness during routing.

Further, in order to improve slip resistance, a layer of anti-skid non-woven fabric is attached to the bottom surface of the base 3.

The above embodiments described are only preferred embodiments of the present invention, and are not intended to limit the protection scope of the present invention. Various modifications and improvements may be made by a person of ordinary skill in the art to the technical schemes of the present invention without departing from the design and spirit of the present invention, which shall all fall within the protection scope defined by the appended claims of the present invention.

1. A rivet riveting folding frame, comprising a folding rod assembly, wherein the folding rod assembly comprises an upper connecting rod group and a lower connecting rod group; the lower connecting rod group comprises a first lower connecting pipe, a second. lower connecting pipe, and a gun-shaped bracket; lower ends of the first lower connecting pipe and the second lower connecting pipe are movably riveted on two inner sides of the gun-shaped bracket by a rivet, respectively; the upper connecting rod group comprises a first upper connecting pipe, a second upper connecting pipe, a first connecting bracket, and a second connecting bracket; upper ends of the first lower connecting pipe and the second lower connecting pipe are movably riveted on an inner side surface of the first connecting bracket by rivets; a lower end of the first upper connecting pipe is movably connected with the first connecting bracket; a lower end of the second upper connecting pipe is movably riveted on the first connecting bracket by a rivet; and upper ends of the first upper connecting pipe and the second upper connecting pipe are movably riveted on the second connecting bracket by rivets.

2. The rivet riveting folding frame according to claim 1, further comprising a telescopic assembly and a base, wherein the telescopic assembly comprises a mounting sleeve and an elastic bolt; the mounting sleeve is fixedly arranged on the base and extends along a vertical direction, and one side of the mounting sleeve is provided with an assembling hole corresponding to the elastic bolt; an assembling pipe is integrally formed at a bottom of the gun-shaped bracket, the assembling pipe being movably arranged in the mounting sleeve and moving along an axial direction of the mounting sleeve, and the elastic bolt is assembled in the assembling hole and abuts against an outer wall of the assembling pipe, so that the assembling pipe is fixed at a specified position.

3. The rivet riveting folding frame according to claim 1, wherein the lower connecting rod group further comprises a pair of first tension springs; both sides of a middle portion of the first lower connecting pipe are assembled with first spring buckles; one end of each of the two first tension springs is buckled to the first spring buckles, and the other ends of the two first tension springs are buckled to both sides of an upper end of the gun-shaped bracket.

4. The rivet riveting folding frame according to claim 1, wherein the upper connecting rod group further comprises a first round head bolt and a first knob having a self-provided nut; the lower end of the first upper connecting pipe passes through the first connecting bracket and the first upper connecting pipe, and is connected with the first knob having the self-provided nut by the first round head bolt, thus realizing movable connection with the first connecting bracket.

5. The rivet riveting folding frame according to claim 1, wherein the upper connecting rod group further comprises a pair of second tension springs; both sides of a middle portion of the first upper connecting pipe are assembled with second spring buckles, and both sides of the first connecting bracket are assembled with third spring buckles; one end of each of the two second tension springs is buckled to the second spring buckle, and the other ends of the two second tension springs are buckled to the third spring buckle.

6. The rivet riveting folding frame according to claim 1, further comprising a clamping assembly, wherein the clamping assembly comprises a second round head bolt, a conjoined clamp, rotatable bracket, and a second knob having a self-provided nut; the second round head bolt passes through the second connecting bracket and the conjoined clamp, and is connected with the second knob having the self-provided nut; and the conjoined clamp deforms and clamps the rotatable bracket.

7. The rivet riveting folding frame according to claim 6, wherein the rotatable bracket is connected with the lamp body or a mobile phone clip.

8. The rivet riveting folding frame according to claim 1, wherein the upper and lower ends of the second upper connecting pipe and the second lower connecting pipe are provided with assembling grooves, and a wiring protection sleeve is mounted in each of the assembling grooves; a wiring channel is provided in each of the wiring protection sleeves, and a wiring hole communicated with the wiring channel is provided in the surface of the wiring protection sleeve; and rivet holes for rivets to pass through are provided on both sides of the wiring protection sleeve.

9. The rivet riveting folding frame according to claim 2, wherein a layer of non-slip non-woven fabric is attached to a bottom surface of the base.
